(19) United States
(12) Patent Application Publication
(10) Pub. No.: US 2015/0202791 A1
(43) Pub. Date: Jul. 23, 2015

(54) Four-Edge Blade and Cutter Head Assembly of a Wood Planing Machine

(71) Applicant: Shinmax Industry Co., Ltd., Taichung City (TW)

(72) Inventor: Chin-Yuan Liu, Taichung City (TW)

(21) Appl. No.: 14/599,661

(22) Filed: Jan. 19, 2015

(30) Foreign Application Priority Data
Jan. 22, 2014 (TW) 103201326

(51) Int. Cl. B27G 13/04; B27C 1/14; B27G 13/00

(52) U.S. Cl. CPC B27G 13/04; B27G 13/005; B27C 1/14

(57) ABSTRACT

A four-edge blade for mounting on a blade carrier of a wood planing machine includes a positioning portion, and a cutting portion connected to the positioning portion. The cutting portion includes an outer surface that serves as an outer surface of said four-edge blade, and four interconnected beveled surfaces extending inclinedly and inwardly from an outer periphery of the outer surface toward the positioning portion.

### CROSS REFERENCE TO RELATED APPLICATION

This application claims priority of Taiwanese Application Number 103201326, filed on Jan. 22, 2014.

### FIELD OF THE INVENTION

The invention relates to a planing machine, more particularly to a four-edge blade and a cutter head assembly of a wood planing machine.

### BACKGROUND OF THE INVENTION

Referring to FIG. 1, a conventional cutter head assembly of a wood planing machine includes a rotary shaft 10, a blade carrier 11 and a plurality of blades 12. The blade carrier 11 is sleeved on the rotary shaft 10, and includes a plurality of mounting surfaces 111, and a plurality of abutment surfaces 112 respectively and inclinedly connected to the mounting surfaces 111. Each of the blades 12 has an inner surface 121, four inclined cutting surfaces 122 and four cutting edges 123.

With the inner surface 121 of each blade 12 abutting against a respective one of the mounting surfaces 111 of the blade carrier 11 and with one of the cutting surfaces 122 of each blade 12 abutting against a corresponding one of the abutment surfaces 112 of the blade carrier 11, each blade 12 can be screwed to the blade carrier 11. If one of the cutting edges 123 of one of the blades 12 is worn out, the one of the blades 12 is rotated so that another one of the cutting edges 123 thereof can be used to process the workpiece (W). Thus, the costs can be economized, and the service life of the conventional cutter head assembly can be prolonged.

However, because one of the cutting surfaces 122 of each blade 12 is used to abut against the corresponding abutment surface 112 of the blade carrier 11, the inner surface 121 of each blade 12 may incline relative to the respective mounting surface 111 of the blade carrier 11 during assembly. This adversely affects the accuracy of assembling and processing of the conventional cutter head assembly.

### SUMMARY OF THE INVENTION

Therefore, an object of the present invention is to provide a four-edge blade that can enhance accuracy of assembling.

Accordingly, a four-edge blade of this invention for mounting on a blade carrier of a wood planing machine comprises a positioning portion, and a cutting portion connected to the positioning portion. The cutting portion includes an outer surface that serves as an outer surface of the four-edge blade, and four interconnected beveled surfaces extending inclinedly and inwardly from an outer periphery of the outer surface toward the positioning portion.

Another object of this invention is to provide a cutter head assembly of a wood planing machine that uses the aforesaid four-edge blade.

Accordingly, a cutter head assembly of a wood planing machine of this invention comprises a rotary shaft, a blade carrier extending around the rotary shaft, and a plurality of four-edge blades respectively disposed on the mounting regions. The blade carrier includes a plurality of mounting regions. Each mounting region includes amounting portion, and an abutment portion extending outwardly from the mounting portion away from the rotary shaft and having an abutment surface substantially perpendicularly connected to the mounting portion. Each of the four-edge blades has inner and outer surfaces, and includes a positioning portion and a cutting portion connected to the positioning portion. The cutting portion has the outer surface, and four interconnected beveled surfaces extending inclinedly and inwardly from an outer periphery of the outer surface toward the positioning portion. The positioning portion of each of the four-edge blades abuts against the mounting portion and the abutment surface of a respective one of the mounting regions.

### BRIEF DESCRIPTION OF THE DRAWINGS

Other features and advantages of the present invention will become apparent in the following detailed description of the embodiment with reference to the accompanying drawings, of which:

FIG. 1 is a schematic view of a conventional cutter head assembly in a state of use;

FIG. 2 is a perspective view of a cutter head assembly according to the embodiment of the present invention;

FIG. 3 is a schematic view of a four-edge blade of the embodiment; and

FIG. 4 is a schematic view of the embodiment in a state of use.

### DETAILED DESCRIPTION OF THE EMBODIMENT

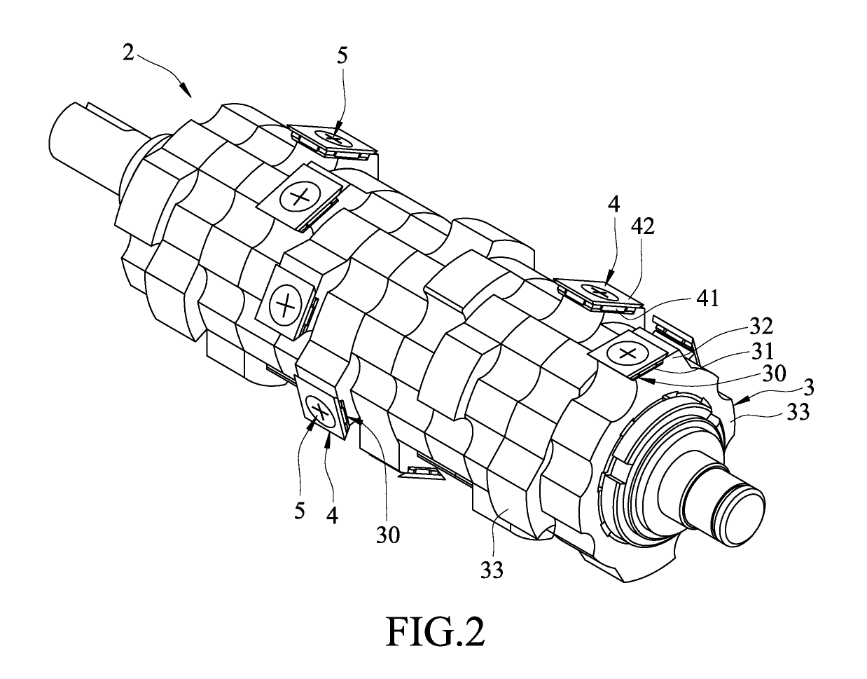

Referring to FIGS. 2 to 4, a cutter head assembly 2 of a wood planing machine (not shown) according to the embodiment of the present invention is shown to comprise a rotary shaft 20, a blade carrier 3, a plurality of four-edge blades 4, and a plurality of fastening screws 5.

The blade carrier 3 extends around the rotary shaft 20, and includes a plurality of mounting regions 30 spaced apart from each other along a spiral direction around an axis of the rotary shaft 20.

Each of the mounting regions 30 includes a mounting portion 31 and an abutment portion 32. The mounting portion 31 extends substantially along a tangential direction of the blade carrier 3, and has a threaded hole 311. The abutment portion 32 extends outwardly from the mounting portion 31 away from the rotary shaft 20, and has an abutment surface 321 substantially perpendicularly connected to the mounting portion 31 and extending substantially along a radial direction of the blade carrier 3, and an outer surface 322 connected transversely to an end of the abutment surface 321 that is distal from the mounting portion 31.

The four-edge blades 4 are respectively disposed on the mounting regions 30. Each of the four-edge blades 4 includes a positioning portion 41, a cutting portion 42 connected to the positioning portion 41, and a tapered hole 43 extending through the cutting portion 42 and the positioning portion 41 for extension of a respective one of the fastening screws 5 therethrough and tapering from the cutting portion 42 toward the positioning portion 41.

The positioning portion 41 includes four positioning surfaces 411 interconnected to form a column, four interconnected inclined guide surfaces 412 extending inclinedly, inwardly and respectively from ends of the positioning surfaces 411 opposite to the cutting portion 42, and an inner surface 414 that serves as an inner surface of the four-edge blade 4 and that interconnects ends of the inclined guide surfaces 413 opposite to the positioning surfaces 411.

The cutting portion 42 includes a connecting surface 421 connected to and disposed around the positioning portion 41, an outer surface 422 that serves as an outer surface of the four-edge blade 4 and that is opposite to the inner surface 414, and four interconnected beveled surfaces 423 extending inclinedly and inwardly from an outer periphery of the outer surface 422 to the connecting surface 421. Specifically, the connecting surface 421 has an inner periphery connected to the positioning surfaces 411 opposite to the inner surface 414, and an outer periphery connected to inner ends of the beveled surfaces 423.

Each positioning surface 411 is substantially perpendicular to the outer surface 422, and is substantially parallel to an outer end of a respective beveled surface 423. Further, each positioning surface 411 forms a right angle with the connecting surface 421.

In this embodiment, each beveled surface 423 is coplanar with a respective inclined guide surface 413. However, in practice, they may be non-coplanar.

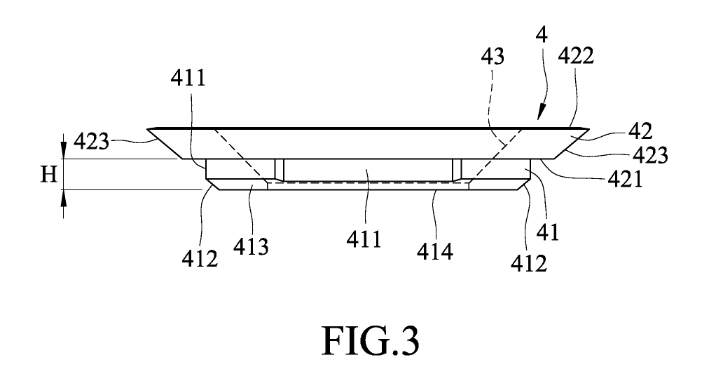

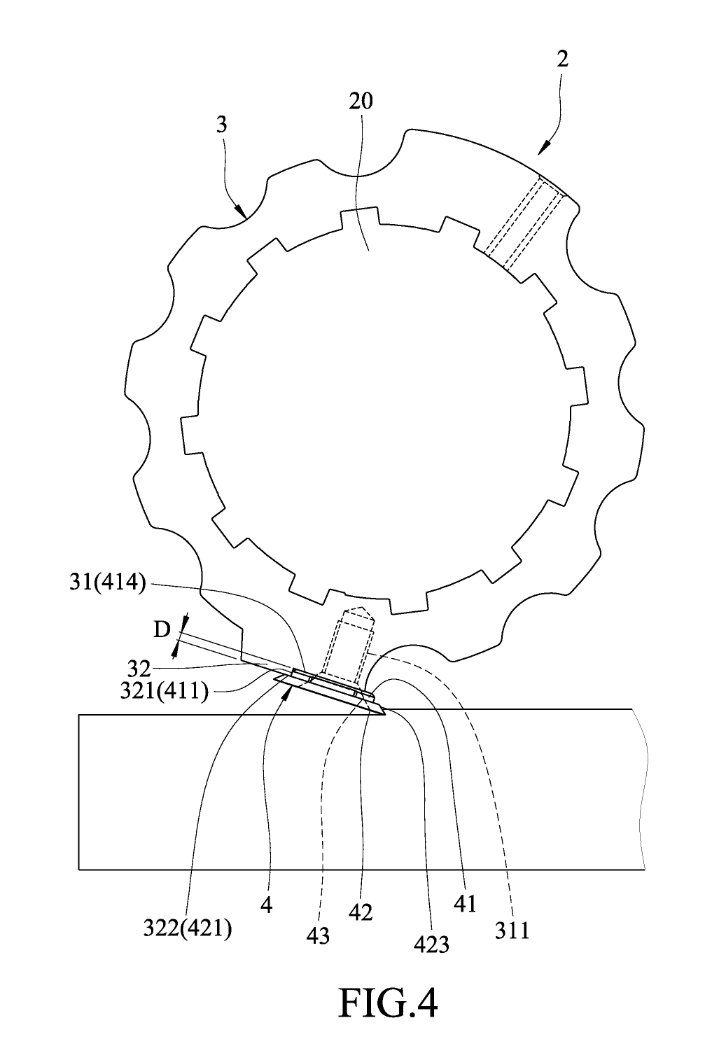

With reference to FIG. 4, each four-edge blade 4 is mounted on the respective mounting region 30 with the inner surface 414 abutting against the mounting portion 31, with one of the positioning surfaces 411 abutting against the abutment surface 321, and with the connecting surface 421 abutting against the outer surface 322 of the abutment portion 32. Further, each four-edge blade 4 is fixed to the respective mounting region 30 by extending each of the fastening screws 5 through the tapered hole 43 of a respective four-edge blade 4 and threadedly engaging the threaded hole 311 of the mounting portion 31 of the respective mounting region 30. The abutment portion 32 of each mounting region 30 extends out of the mounting portion 31 of the respective mounting region at a distance (D) (see FIG. 4) which is smaller than a height (H) (see FIG. 3) of the positioning portion 41 of the respective four-edge blade 4.

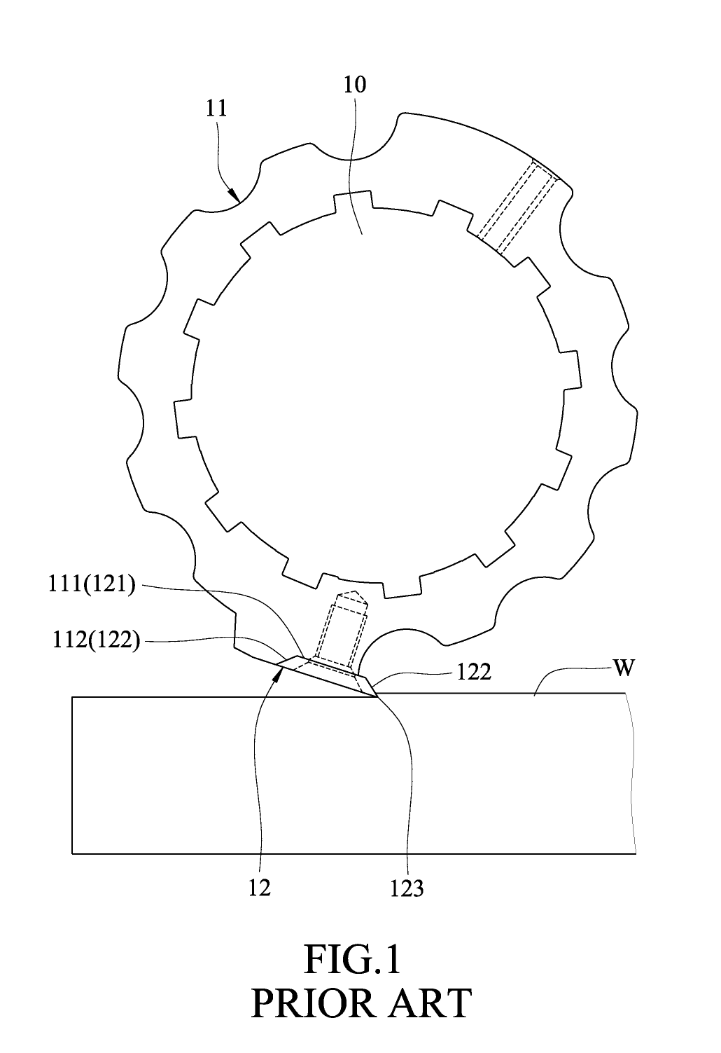

With the inclined guide surfaces 412 being coplanar with the respective beveled surfaces 423, each four-edge blade 4 may also be mounted on the conventional blade carrier 11 (see FIG. 1). In this case, each inclined guide surface 412 and the corresponding beveled surface 423 of each four-edge blade 4 may abut against a corresponding one of the abutment surfaces 112 of the conventional blade carrier 1. The effect of limiting each four-edge blade 4 may also be achieved.

In this embodiment, the blade carrier 3 is composed of a plurality of cutter discs 33 sleeved on the rotary shaft 20. Alternatively, the blade carrier 3 may be integrally formed (not shown) as one body. The blade carrier 3 may also be applied to a blade of a spiral planer tool disclosed in Taiwanese Patent Number M362754 filed by the applicant of this invention.

It is worth to mention that the four-edge blades 4 may be manufactured and sold independently, and are not necessarily sold together with the blade carrier 3.

In sum, in comparison with the conventional blade 12 (see FIG. 1) which uses one of the inclined cutting surfaces 122 for abutment, each four-edge blade 4 of this invention uses the positioning portion 41 thereof to perpendicularly abut against the abutment portion 32 of the respective mounting region 30, so that each four-edge blade 4 can be more stably and accurately positioned on the respective mounting region 30 of the blade carrier 3. Therefore, the objects of this invention can be realized.

While the present invention has been described in connection with what is considered the most practical embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A four-edge blade for mounting on a blade carrier of a wood planing machine, comprising:
a positioning portion; and
a cutting portion connected to said positioning portion and including an outer surface that serves as an outer surface of said four-edge blade, and four interconnected beveled surfaces extending inclinedly and inwardly from an outer periphery of said outer surface toward said positioning portion.

2. The four-edge blade as claimed in claim 1, wherein said positioning portion includes four positioning surfaces interconnected to forma column, each of said positioning surfaces being substantially perpendicular to said outer surface and being substantially parallel to an outer end of a respective one of said beveled surfaces.

3. The four-edge blade as claimed in claim 2, wherein said cutting portion further includes a connecting surface connected to and disposed around said positioning portion, said connecting surface having an inner periphery connected to said positioning surfaces, and an outer periphery connected to said inner ends of said beveled surfaces, each of said positioning surfaces forming a right angle with said connecting surface.

4. The four-edge blade as claimed in claim 3, wherein said positioning portion further includes four interconnected inclined guide surfaces extending inclinedly, inwardly and respectively from said positioning surfaces opposite to said connecting surface, and an inner surface that serves as an inner surface of said four-edge blade and that interconnects said inclined guide surfaces opposite to said positioning surfaces.

5. A cutter head assembly of a wood planing machine, comprising:
a rotary shaft;
a blade carrier extending around said rotary shaft and including a plurality of mounting regions, each of said mounting regions including amounting portion, and an abutment portion extending outwardly from said mounting portion away from said rotary shaft and having an abutment surface substantially perpendicularly connected to said mounting portion; and
a plurality of four-edge blades respectively disposed on said mounting regions, each of said four-edge blades having inner and outer surfaces, and including a positioning portion and a cutting portion connected to said positioning portion, said cutting portion having said outer surface, and four interconnected beveled surfaces extending inclinedly and inwardly from an outer periphery of said outer surface toward said positioning portion;
wherein said positioning portion of each of said four-edge blades abuts against said mounting portion and said abutment surface of a respective one of said mounting regions.

6. The cutter head assembly as claimed in claim 5, wherein said positioning portion of each of said four-edge blades includes four positioning surfaces interconnected to form a column, each of said positioning surfaces being substantially perpendicular to said outer surface and being substantially parallel to an outer end of a respective one of said beveled surfaces.

7. The cutter head assembly as claimed in claim 6, wherein said cutting portion of each of said four-edge blades further includes a connecting surface connected to and disposed around said positioning portion, said connecting surface having an inner periphery connected to said positioning surfaces, and an outer periphery connected to said inner ends of said beveled surfaces, each of said positioning surfaces forming a right angle with said connecting surface.

8. The cutter head assembly as claimed in claim 7, wherein said abutment portion extends out of said mounting portion at a distance (D) which is smaller than a height (H) of said positioning portion of a respective one of said four-edge blades.

9. The cutter head assembly as claimed in claim 8, wherein said mounting regions are spaced apart from each other along a spiral direction around an axis of said rotary shaft, said mounting portion extending substantially along a tangential direction of said blade carrier, said abutment surface of said abutment portion extending substantially along a radial direction of said blade carrier.

10. The cutter head assembly as claimed in claim 9, further comprising a plurality of fastening screws, each of said four-edge blades further including a tapered hole extending through said cutting portion and said positioning portion, said mounting portion of each of said mounting regions having a threaded hole, each of said fastening screws extending through said tapered hole of a respective one of said four-edge blades and threadedly engaging said threaded hole of said mounting portion of a corresponding one of said mounting regions.
